(19) United States
(12) Patent Application Publication
(10) Pub. No.: US 2017/0182641 A1
(43) Pub. Date: Jun. 29, 2017

(54) A MULTIFUNCTIONAL SCREWDRIVER

(71) Applicant: Shanghai Easy-Use Tools Enterprise Co. Ltd., Minhang District, Shanghai (CN)

(72) Inventor: Shiyu SUN, Minhang District, Shanghai (CN)

(73) Assignee: Shanghai Easy-Use Tools Enterprise Co. Ltd., Minhang District, Shanghai (CN)

(21) Appl. No.: 15/307,173

(22) PCT Filed: Aug. 4, 2016
(86) PCT No.: PCT/CN2016/093283

§ 371 Date: Oct. 27, 2016

(30) Foreign Application Priority Data
Aug. 12, 2015 (CN) 201520606638.X

(51) Int. Cl. B25B 23/00; B25G 1/10; B25B 15/02

(52) U.S. Cl. CPC B25B 23/0035; B25B 15/02; B25G 1/102

(57) ABSTRACT

This discloses a multifunctional screwdriver comprising a handle and a matching shaft, the matching shaft holds one end of the handle, wherein the matching shaft apart from the handle opens two screwdriver head holes comprising a first screwdriver head hole and a second screwdriver head hole which are provided at the end of the handle, the second screwdriver head hole provided at the bottom of the first screwdriver head hole. In the present patent application, two screwdriver head holes are provided at the end of the matching shaft, the second screwdriver head hole is provided at the bottom of the first screwdriver set head hole, satisfying the use of the screwdriver head in different thickness and length, so that the matching shaft can be matched with two types of screwdriver head, improving the using efficiency of the screwdriver.

### CROSS-REFERENCE TO RELATED APPLICATIONS

The present application claims priority to and the benefit of Chinese Patent Application No. CN 201520606638.X, filed on Aug. 12, 2015, the entire content of which is incorporated herein by reference.

### BACKGROUND OF THE INVENTION

1. Field of the Invention

The present patent application related to the field of a daily hardware, more specifically, to a multifunctional screwdriver.

2. Description of the Related Art

The existing screwdriver provides a lot of conveniences to people's life, which is mainly used to fasten or loosen screws. The structure of the most common screwdriver in prior art generally includes a screwdriver handle, a screwdriver rod and a screwdriver head, and the screwdriver handle, screwdriver rod and screwdriver head are fixed as an one-piece structure. The ordinary screwdriver can only correspond to one kind of screwdriver head, it is necessary to replace different screwdrivers, when different sizes of screwdriver heads need to use, and the operator must be equipped with screwdrivers in different sizes. It is inconvenient to carry the screwdriver and replace the screwdriver heads.

### SUMMARY OF THE PATENT APPLICATION

In view of this, the present patent application provides a multifunctional screwdriver in order to solve the problem that a screwdriver in one specification can only be matched with a screwdriver head in one size specification.

In order to achieve the objectives disclosed above, the technical proposals of the present patent application are realized as follow:

A multifunctional screwdriver, comprising a handle and a matching shaft, the matching shaft holds one end of the handle, wherein the end of the matching shaft apart from the handle opens two screwdriver head holes, comprising a first screwdriver head hole and a second screwdriver head hole which are formed at the bottom of the first screwdriver head hole.

Preferably, the multifunctional screwdriver as disclosed above, wherein the handle has a plurality of concave points which are formed around the external of the circumference of the handle.

Preferably, the multifunctional screwdriver as disclosed above, wherein the handle is configured with an inner concave structure at the end of the matching shaft.

Preferably, the multifunctional screwdriver as disclosed above, wherein the center line of the first screwdriver head hole and that of the second screwdriver head hole are the same line.

Preferably, the multifunctional screwdriver as disclosed above, wherein also comprises a first screwdriver head, which is detachably mounted within the first screwdriver head hole.

Preferably, the multifunctional screwdriver as disclosed above, wherein also comprises a second screwdriver head, which is detachably mounted within the second screwdriver head hole.

Since the present patent application adopts the technique above, positive effects can be achieved as follows:

In the present patent application, two screwdriver head holes are formed at the end of the matching shaft, the second screwdriver head hole is formed at the bottom of one screwdriver head hole, satisfying the use of the screwdriver head in different thickness and length, so that the matching shaft can be matched with two types of screwdriver head in use, which improves the using efficiency of the screwdriver.

### BRIEF DESCRIPTIONS OF THE DRAWINGS

Accompanying drawings constituting part of the present patent application is provided for further comprehension of the present patent application, the present patent application of exemplary embodiments and illustration thereof are provided to explain the present patent application, which does not limit the scope of the present patent application. In the accompanying drawings:

FIG. 1 is a structure diagram of a multifunctional screwdriver according to the present patent application;

FIG. 2 is a cross-section of the matching shaft of a multifunctional screwdriver according to the present patent application;

FIG. 3 is an explosive view of the matching shaft and the screwdriver head of a multifunctional screwdriver according to the present patent application;

FIG. 4 is an assembly diagram of the matching shaft and the first screwdriver head of a multifunctional screwdriver according to the present patent application;

FIG. 5 is an assembly diagram of the matching shaft and the second screwdriver head of a multifunctional screwdriver according to the present patent application.

### DESCRIPTIONS OF THE PREFERRED EMBODIMENTS

Hereinafter, certain embodiments according to the present patent application will be described with reference to the accompanying drawings below, but do not limit the scope of the present patent application.

### Embodiments

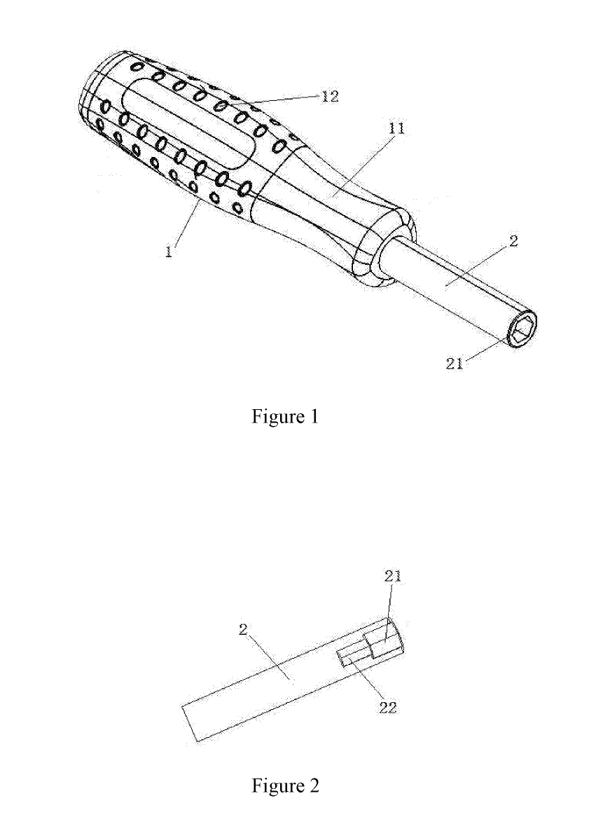

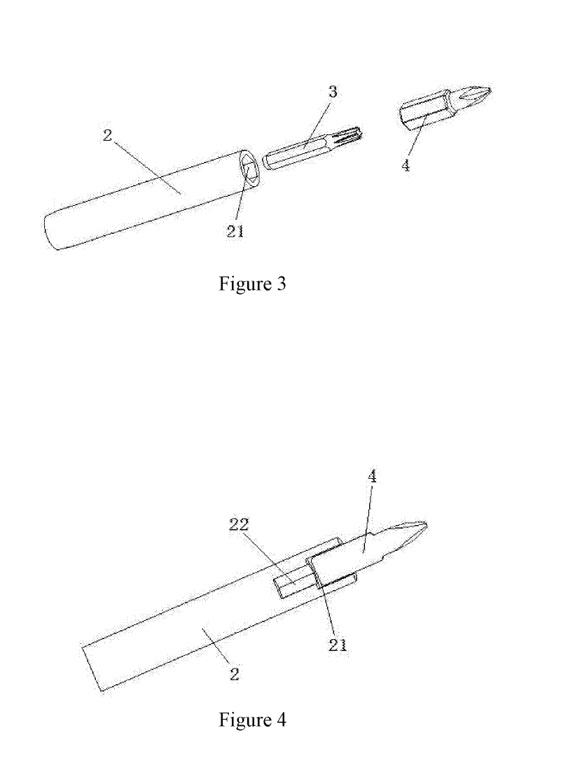

Please refer to FIGS. 1 to 5, the multifunctional screwdriver of the present patent application, comprising a handle 1 and a matching shaft 2, the matching shaft holds one end of the handle 1, wherein the end of the matching shaft 2 apart from the handle 1 opens two screwdriver head holes, comprising a first screwdriver head hole 21 and a second screwdriver head hole 22, which is formed at the bottom of the first screwdriver head hole.

On basis of the above, the patent application further provides the following embodiments, please continue referring to FIGS. 1 to 5,

In a further embodiment of the present patent application, the handle 1 has a plurality of concave points 12, which are formed around the external of the circumference of the handle to increase the friction between the hand and the handle, which is more convenient to use the handle when in operation.

In a further embodiment of the present patent application, the center line of the first screwdriver head hole 21 and that of the second screwdriver head hole 22 are the same line.

Users can further understand the characteristics and functions of the present patent application according to the following illustrations.

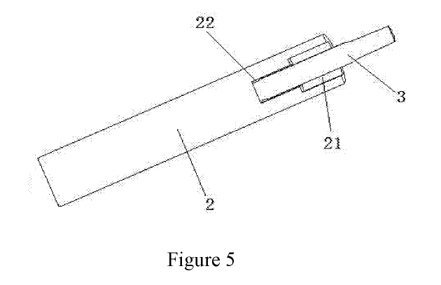

As shown in FIGS. 4 and 5, in this embodiment, a first screwdriver head 4 is detachably provided within the first screwdriver head hole 21; a second screwdriver head 3 is detachably provided within the second screwdriver head hole 22. Wherein, the first screwdriver head 4 is thicker than the second screwdriver head 3, the first screwdriver head is thus matched with the first screwdriver head hole 21, and the second screwdriver head 3 is thinner than the first screwdriver head 4, the second screwdriver head is thus matched with the second screwdriver head hole 22.

In summary, in the present patent application, two screwdriver head holes are formed at the end of the matching shaft, the second screwdriver head hole is formed at the bottom of the first screwdriver set head hole, satisfying the use of the screwdriver head in different thicknesses and lengths, so that the matching shaft can be matched with two types of screwdriver head, which improves the using efficiency of the screwdriver.

The above mentioned is merely the better embodiment of the patent application, the implementation method and the protection scope of the patent application are not limited by that, for artisan in this field, it is to be understood that the equivalent replacement and the obvious change of the specification and the illustrations of the present patent application shall be included in the protection scope of the present patent application.

What is claimed is:

1. A multifunctional screwdriver, comprising a handle and a matching shaft, the matching shaft holds one end of the handle, wherein an end of the matching shaft that apart is from the handle opens two screwdriver head holes, the two screwdriver head holes comprise a first screwdriver head hole and a second screwdriver head hole, the second screwdriver head hole is provided at bottom of the first screwdriver head hole.

2. A multifunctional screwdriver as claimed in claim 1, wherein the handle has a plurality of concave points, the plurality of concave points are provided around externals of the circumference of the handle.

3. A multifunctional screwdriver as claimed in claim 1, wherein the handle is configured with an inner concave structure at one end of the matching shaft.

4. A multifunctional screwdriver as claimed in claim 1, wherein the first screwdriver head hole has a same center line with the second screwdriver head hole.

5. A multifunctional screwdriver as claimed in claim 1, wherein further comprising a first screwdriver head, the first screwdriver is detachably installed within the first screwdriver head hole.

6. A multifunctional screwdriver as claimed in claim 1, wherein further comprising a second screwdriver head, the second screwdriver is detachably installed within the second screwdriver set head hole.
